(19) United States
(12) Patent Application Publication
(10) Pub. No.: US 2019/0299760 A1
(43) Pub. Date: Oct. 3, 2019

(54) SUNROOF APPARATUS

(71) Applicant: AISIN SEIKI KABUSHIKI KAISHA, Kariya-shi, Aichi-ken (JP)

(72) Inventors: Ryuta FUKADA, Kariya-shi (JP); Akinori OSAMURA, Chiryu-shi (JP); Yusuke SATO, Kariya-shi (JP)

(73) Assignee: AISIN SEIKI KABUSHIKI KAISHA, Kariya-shi, Aichi-ken (JP)

(21) Appl. No.: 16/071,247

(22) PCT Filed: Jan. 19, 2017
(86) PCT No.: PCT/JP2017/001798

§ 371 Date: Jul. 19, 2018

(30) Foreign Application Priority Data
Jan. 29, 2016 (JP) 2016-015955

(51) Int. Cl. B60J 7/043; B60J 7/047; F16B 5/02

(52) U.S. Cl. CPC B60J 7/043; F16B 5/02; B60J 7/047

(57) ABSTRACT

A sunroof apparatus includes a base panel (20) made of aluminum alloy and provided at a peripheral edge portion of an opening (11) formed at a body (10) of a vehicle, a sunroof unit (25) attached to the base panel (20), and a panel (13) arranged above the base panel (20), the panel being connected to the sunroof unit (25).

### TECHNICAL FIELD

The present invention relates to a sunroof apparatus.

### BACKGROUND ART

As a sunroof apparatus, various types apparatuses are conventionally suggested (refer to Patent document 1, for example). Such a sunroof apparatus includes a base panel (a roof frame) provided at a body of a vehicle.

### DOCUMENT OF PRIOR ART

### Patent Document

Patent document 1: JP2008-81108A

### OVERVIEW OF THE INVENTION

### Problem to be Solved by the Invention

For material of the base panel, for example, material including only an iron plate, material including only resin and material including a combination of an iron plate and resin are employed. The base panel is fixed to the body of the vehicle by bolt fastening and/or with adhesive, for example. In a case where the material of the base panel includes only the iron plate, due to increment of the mass of the base panel, fuel consumption is forced to deteriorate, and/or a running stability is forced to decrease by a heightened center of gravity of the vehicle. On the other hand, in a case where the material of the base panel includes only the resin, the base panel is forced to increase in its size to ensure a sufficient rigidity. In a case where the material of the base panel includes the combination of the iron plate and the resin, manufacturing man-hours is forced to increase because the base panel is manufactured by insert molding, for example.

An objective of the present invention is to provide a sunroof apparatus which can be reduced more in weight.

### Means for Solving Problem

A sunroof apparatus solving the above-stated problem includes a base panel made of aluminum alloy and provided at a peripheral edge portion of an opening formed at a body of a vehicle, a sunroof unit attached to the base panel, and a panel arranged above the base panel and connected to the sunroof unit.

According to the above-explained configuration, the base panel is made of the aluminum alloy, and therefore the sunroof apparatus as a whole can be reduced more in weight compared to a case where the base panel is made of, for example, iron. With regard to the above-explained sunroof apparatus, it is ideal that the sunroof apparatus further includes a fastener made of iron and including a head portion facing the base panel wherein the fastener fastens the peripheral edge portion of the opening and the base panel, and resin film interposed between the base panel and the head portion.

According to the above-explained configuration, the resin film is provided between the base panel and the head portion, and thus corrosion caused by contact of dissimilar metals to each other can be restricted from occurring. With regard to the above-explained sunroof apparatus, it is ideal that the resin film corresponds to adhesive or coating film covering the head portion.

According to the above-explained configuration, for example, in a case where the resin film is the adhesive, the head portion (the fastener) can be prevented from rotating. On the other hand, in a case where the resin film is the coating film, the resin film can be formed via a simple work of applying painting and/or coating onto the head portion.

With regard to the above-explained sunroof apparatus, it is ideal that the sunroof apparatus further includes a washer made of iron and mounted on the base panel, a bolt made of iron wherein the bolt includes a head portion welded to the washer and includes a shank portion penetrating the peripheral edge portion of the opening and the base panel, a nut threadedly engaged to the shank portion, and fastening the peripheral edge portion of the opening and the base panel in cooperation with the head portion, and resin film interposed between the base panel and the washer.

According to the above-explained configuration, the resin film is provided between the base panel and the washer, and thus corrosion due to contact of dissimilar metals to each other can be restricted from occurring. In addition, by providing the washer between the head portion and the base panel, the bolt can be prevented from co-rotating when the base panel is fastened relative to the peripheral edge portion of the opening, for example.

With regard to the above-explained sunroof apparatus, it is ideal that the resin film corresponds to adhesive or coating film covering the washer. According to this configuration, for example, in a case where the resin film is the adhesive, the washer and the bolt can be prevented from rotating. On the other hand, in a case where the resin film is the coating film, the resin film can be formed with a simple work of applying painting and/or coating to the washer.

It is ideal that the above-explained sunroof apparatus further includes plural fastening members fastening the washer to the base panel at respective positions which differ from each other. According to this configuration, the washer is fastened to the base panel at the plural locations with the plural fastening members, and therefore the washer and the bolt can be more prevented from rotating.

### Effect of the Invention

The present invention includes an effect of reducing a weight of a sunroof apparatus more.

### BRIEF DESCRIPTION OF DRAWINGS

FIGS. 1A and 1B illustrate a sunroof apparatus of an embodiment of the present invention when being fully closed and when fully open, respectively.

FIG. 2 is an exploded perspective view of the sunroof apparatus of the embodiment.

FIG. 3 is a cross-sectional view taken along line 3-3 of FIG. 2.

FIG. 4 is a cross-sectional view corresponding to FIG. 3, wherein FIG. 4 illustrates a sunroof apparatus of a variation of the present invention.

### MODE FOR CARRYING OUT THE INVENTION

A sunroof apparatus of an embodiment of the present invention will be explained hereunder. In the following explanation, a front and rear direction of a vehicle will be referred to as “a front and rear direction” and an upper side and a lower side in a height direction of the vehicle will be referred to as “an upper side” and “a lower side”, respectively.

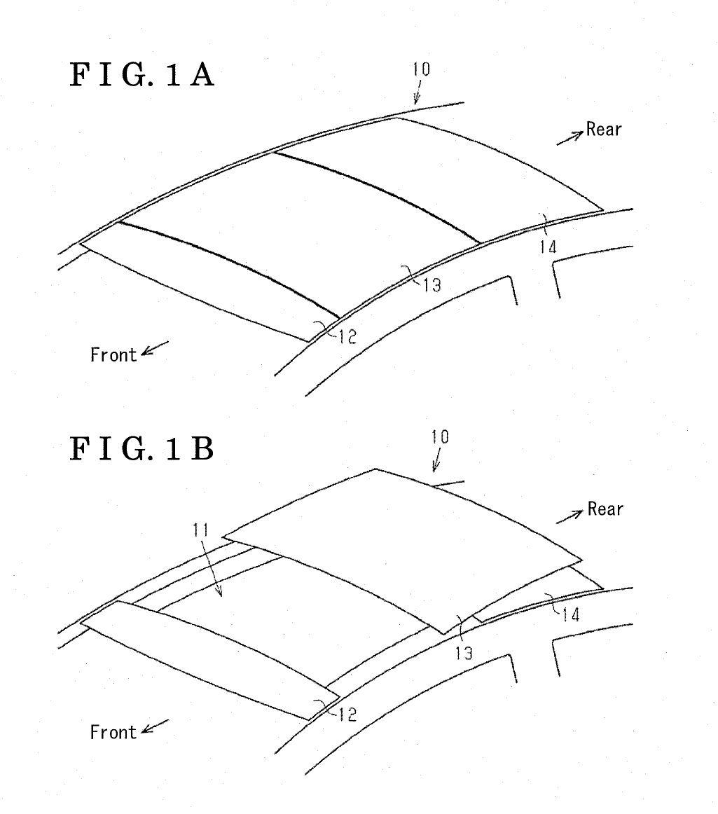

As illustrated in FIGS. 1A and 1B, a roof 10 of a vehicle including an automobile is provided with an opening 11 formed in a substantially quadrangular shape. The roof 10 is also provided with a front roof panel 12, a center roof panel 13 serving as a panel and a rear roof panel 14 which are arranged side by side with one another in the front and rear direction. Each of the front roof panel 12, the center roof panel 13 and the rear roof panel 14 includes a substantially quadrangular shape, and is made of glass or resin, for example. The front roof panel 12 and the rear roof panel 14 are attached to normally close a front portion and a rear portion of the opening 11, respectively. To the contrary, the center roof panel 13 is attached to be able to open and close a central portion of the opening 11 in the front and rear direction. That is, the center roof panel 13 is attached to be able to perform a tilt up operation in which a rear portion of the center roof panel 13 rises using a front portion of the center roof panel 13 as a fulcrum and a slide operation in the front and rear direction. With regard to an opening and closing operation performed by the center roof panel 13, a so-called outer sliding method is employed, wherein the slide operation is performed while the tilt up state is maintained.

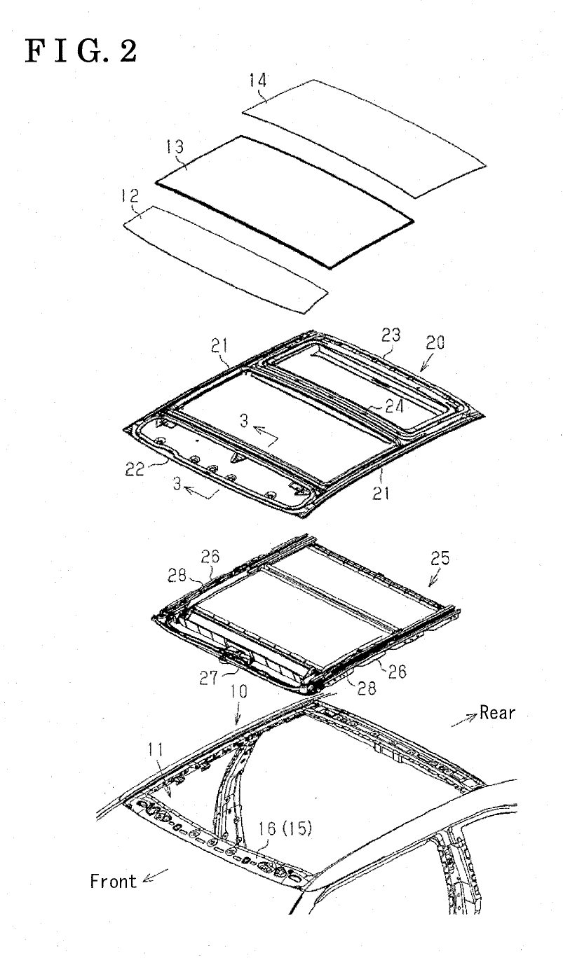

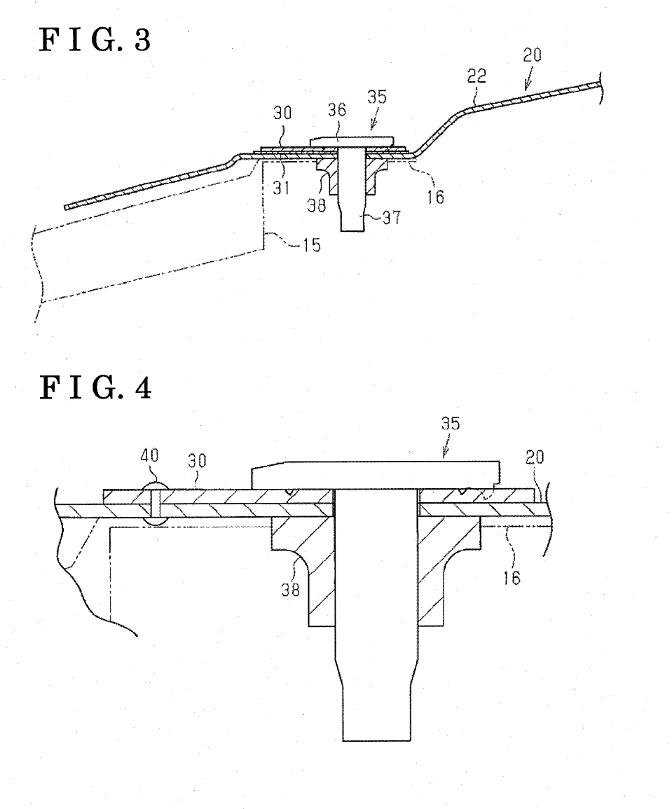

As illustrated in FIGS. 2 and 3, the roof 10 includes an inner panel 15 made of iron and forming a peripheral edge portion of the opening 11. The inner panel 15 is provided with an attachment portion 16 including a substantially flange configuration extended towards the center of the opening 11 from over a substantially entire periphery of the opening 11. Coating film formed of resin is provided at least on an upper surface of the attachment portion 16. A base panel 20 formed of pressed material made of an aluminum alloy single plate is provided above the inner panel 15. The base panel 20 includes side frames 21 provided as a pair, a front frame 22 and a rear frame 23. The side frames 21 are extended along respective side edge portions of the opening 11 in a vehicle width direction, respectively. The front frame 22 and the rear frame 23 are extended along a front edge portion and a rear edge portion of the opening 11, respectively. The base panel 20 also includes an intermediate frame 24 extended in the vehicle width direction to connect intermediate portions, in the front and rear direction, of the respective side frames 21 to each other. That is, the base panel 20 includes a portion formed in a quadrangular frame shape and formed by the both side frames 21, the front frame 22 and the rear frame 23. At each of the side frames 21, the front frame 22 and the rear frame 23, the base panel 20 is mounted on the attachment portion 16 of the inner panel 15 and is fixed thereto.

A sunroof unit 25 is attached to the base panel 20. The sunroof unit 25 is provided below the base panel 20. The sunroof unit 25 includes a pair of guide rails 26 and a front housing 27. The guide rails 26 are extended in the front and rear direction along the respective side frames 21 of the base panel 20. The front housing 27 is extended in the vehicle width direction along the front frame 22 of the base panel 20. Each of the guide rails 26 is made of aluminum alloy extruded material, for example. The front housing 27 is made of resin material, for example, and connects front ends of the respective guide rails 26 to each other.

The sunroof unit 25 includes function parts 28 supported by the guide rails 26, respectively, to be movable in the front and rear direction. The function parts 28 are provided as a pair. The center roof panel 13 is connected to the function parts 28 and supported thereby in a state where the center roof panel 13 bridges between the function parts 28. The center roof panel 13 performs the opening and closing operation in association with the movement of the function parts 28 in the front and rear direction.

Next, a structure of mounting and fixing the base panel 20 relative to the attachment portion 16 of the inner panel 15 will be explained. The base panel 20 is configured to be mounted on the attachment portion 16 from above and be fixed thereat, in a form a module where the panels 12 to 14 and the sunroof unit 25 are assembled to the base panel 20 in advance. Structures of mounting and fixing the side frames 21, the front frame 22 and the rear frame 23 on the attachment portion 16 are equivalent to one another, and therefore an explanation will be made for the front frame 22 as a representative case.

FIG. 3 illustrates a state in which the front frame 22 is overlapped on the attachment portion 16. For example, a washer 30 made of iron and including a substantially quadrangular plate shape is mounted on the front frame 22 above the attachment portion 16. That is, the washer 30 is joined to the front frame 22 in a state of being electrically insulated by, for example, adhesive 31 made of urethane resin and interposed between the washer 30 and the front frame 22. A head portion 36 of a bolt 35 made of iron is mounted on the washer 30. That is, the head portion 36 is joined to the washer 30 by welding, for example. The bolt 35 includes a shank portion 37 of which an axis extends in the vehicle height direction and which penetrates the washer 30, the front frame 22 and the attachment portion 16. A nut 38 is threadedly engaged to the shank portion 37 of the bolt 35, wherein the shank portion 37 passes downwardly through the washer 30, the front frame 22 and the attachment portion 16. Thus, in cooperation with the head portion 36 and the nut 38 with each other with the washer 30 interposed therebetween, the attachment portion 16 and the front frame 22 are fastened to each other. The nut 38 is made of iron, for example, and coating film made of resin is formed on an upper surface of the nut 38.

The attachment portion 16 and the front frame 22 are fastened to each other with, for example, the bolt 35 and the nut 38 at plural positions wherein the plural positions are spaced away from each other in an extending direction of the front frame 22 in a similar manner. The base panel 20 is fastened to the attachment portion 16 at plural positions of the rear frame 23 wherein the plural positions are separated from each other in an extending direction of the rear frame 23 and/or at plural positions of each of the side frames 21 wherein the plural positions are spaced away from each other in an extending direction of the side frame 21, in a similar manner. That is, the nuts 38 are fastened from below to the respective shank portions 37 of the plural bolts 35 each penetrating the attachment portion 16, and accordingly the base panel 20, which is to be assembled from above to the attachment portion 16, is mounted on the attachment portion 16 (the inner panel 15).

Next, an operation and effect of the present embodiment will be explained. (1) In the present embodiment, the base panel 20 is made of the aluminum alloy, and therefore the sunroof apparatus as a whole can be reduced more in weight compared to a case where the base panel 20 is made of, for example, iron. Consequently, fuel consumption of the vehicle can be enhanced. In addition, a running stability can be enhanced because a center of gravity of the vehicle is lowered.

(2) In the present embodiment, the adhesive 31 is provided between the base panel 20 and the washer 30, and thus corrosion due to contact of different types of metals to each other can be restricted from occurring. By providing the washer 30 between the head portion 36 of the bolt 35 and the base panel 20, the washer 30 is in contact with the base panel 20 at a large area, and thus a high frictional force is generated. As a result, the bolt 35 can be prevented from co-rotating when the base panel 20 is fastened to the attachment portion 16.

(3) In the present embodiment, the adhesive 31 is provided between the base panel 20 and the washer 30, and thus the washer 30 and the bolt 35 can be prevented from rotating. (4) In the present embodiment, base panel 20 is formed by the pressed material formed of a single plate made of aluminum alloy, and thus the number of parts can be reduced.

(5) Generally, a normal roof which is made of aluminum alloy and on which a sunroof is not mounted is attached, with the use of adhesive, to a roof (an inner panel) including a structure conforming to the roof 10. Therefore, because the base panel 20 is made of the aluminum alloy, the base panel 20 can be attached by adhesion to the roof 10 by utilizing a production line that is same as a production line for attaching the normal roof by adhesion. Consequently, manufacturing man-hours and costs can be reduced compared to a case where a new production line is established separately.

The aforementioned embodiment may be changed as follows. As illustrated in FIG. 4, a rivet pin 40 serving as a fastening member may be provided between the washer 30 and the base panel 20, and the washer 30 may be fastened to the base panel 20 with the use of the rivet pin 40. In this case, the adhesive 31 may be omitted or the adhesive 31 does not need to be omitted. In a case where the rivet pin 40 is provided without omitting the adhesive 31, the washer 30 and the bolt 35 can be further prevented from rotating. It is desirable that the rivet pin 40 is provided at plural positions of the washer 30. Also in this case, the washer 30 and the bolt 35 can be even more prevented from rotating.

In the aforementioned embodiment, coating film made of resin which serves as resin film (which covers the washer 30) may be formed on a bottom surface of the washer 30, instead of the adhesive 31 or in addition to the adhesive 31. In this case, the resin form interposed between the base panel 20 and the washer 30 can be formed by a simple work for applying painting and/or coating onto the washer 30.

In the aforementioned embodiment, an iron rivet pin may be employed instead of the bolt 35 and the nut 38. Also in this case, it is desirable that a head portion of the rivet pin is welded to the washer 30.

In the aforementioned embodiment, the washer 30 may be omitted. In this case, the coating film made of resin which serves as the resin film (which covers the head portion 36) may be formed at a bottom surface of the head portion 36 of the bolt 35 serving as a fastener that is contact directly with the base panel 20, so that the base panel 20 and the head portion 36 are electrically insulated from each other. In this case, the resin film interposed between the base panel 20 and the head portion 36 can be formed by the simple work for applying painting and/or coating onto the head portion 36.

Or, for example, urethane resin adhesive serving as the resin film may be interposed between the base panel 20 and the bottom surface of the head portion 36 of the bolt 35 that is in contact directly with the base panel 20 so that the base panel 20 and the head portion 36 are electrically insulated from each other. In this case, the head portion 36 (the bolt 35) can be prevented from rotating.

The above explanation applies to a case in which the iron rivet pin fastening the attachment portion 16 and the base panel 20 is used instead of the bolt 35 and the nut 38, and the washer 30 is omitted.

In the aforementioned embodiment, the base panel 20 may be adhered to the attachment portion 16 over the entire periphery with, for example, urethane resin adhesive. In this case, bond strength of the base panel 20 relative to the attachment portion 16 increases, thereby enhancing rigidity of the sunroof apparatus or enhancing water tightness.

In the aforementioned embodiment, the base panel 20 to which the sunroof unit 25 is attached may include a quadrangular frame shape. That is, the intermediate frame 24 may be omitted. In the aforementioned embodiment, the front roof panel 12 may be a deflector panel performing a tilt up operation in conjunction with the opening operation of the center roof panel 13.

In the aforementioned embodiment, the center roof panel 13 may be a fixed panel normally closing the opening 11. On the other hand, the rear roof panel 14 may be a movable panel which can open and close the opening 11.

### EXPLANATION OF REFERENCE NUMERALS

11 . . . opening, 13 . . . center roof panel (panel), 16 . . . attachment portion (peripheral edge portion), 20 . . . base panel, 25 . . . sunroof unit, 30 . . . washer, 31 . . . adhesive (resin film), 35 . . . bolt, 36 . . . head portion, 37 . . . shank portion, 38 . . . nut, 40 . . . rivet pin (fastening member)

1. A sunroof apparatus comprising:
a base panel made of aluminum alloy and provided at a peripheral edge portion of an opening formed at a body of a vehicle;
a sunroof unit attached to the base panel; and
a panel arranged above the base panel, the panel being connected to the sunroof unit.

2. The sunroof apparatus according to claim 1, further comprising:
a fastener made of iron and including a head portion facing the base panel, the fastener fastening the peripheral edge portion of the opening and the base panel; and
resin film interposed between the base panel and the head portion.

3. The sunroof apparatus according to claim 2, wherein the resin film corresponds to adhesive or coating film covering the head portion.

4. The sunroof apparatus according to claim 1, further comprising:
a washer made of iron and mounted on the base panel;
a bolt made of iron, the bolt including a head portion welded to the washer, the bolt including a shank portion penetrating the peripheral edge portion of the opening and the base panel;
a nut threadedly engaged to the shank portion, and fastening the peripheral edge portion of the opening and the base panel in cooperation with the head portion; and
resin film interposed between the base panel and the washer.

5. The sunroof apparatus according to claim 4, wherein the resin film corresponds to adhesive or coating film covering the washer.

6. The sunroof apparatus according to either claim 4, further comprising:
a plurality of fastening members fastening the washer to the base panel at respective positions which differ from each other.
